(19) United States
(12) Patent Application Publication
(10) Pub. No.: US 2010/0241740 A1
(43) Pub. Date: Sep. 23, 2010

(54) SYSTEM AND METHOD FOR RESOLVING NETWORK ADDRESSES

(75) Inventor: Charles HENRICH, San Francisco, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 12/409,339

(22) Filed: Mar. 23, 2009

(51) Int. Cl. G06F 15/177

(52) U.S. Cl. 709/222

(57) ABSTRACT

A method of resolving network addresses in a network includes: receiving a network address for a client; accessing a document for the client, wherein the document includes one or more resource requests that each include a corresponding resource network name; resolving one or more resource network addresses for the one or more resource requests; and providing to the client's network address a resolved configuration corresponding to the document, wherein the resolved configuration includes the one or more resource network addresses.

### BACKGROUND OF THE INVENTION

1. Field of Invention

The present invention relates to computer networks generally and more particularly to efficient resolution of network addresses.

2. Description of Related Art

In general, an Internet web page can be represented by a text-based document that may include multiple resource requests that correspond to graphical display items, configuration documents for control display, or other programs that require access over the network. In general, each resource request includes a resource location on the Internet or some restricted network where these resource locations correspond to file locations or places where content is generated. When a web browser at a client machine receives this web page document from a server, the resource requests generally include DNS (Domain Name System) names that must be resolved into IP (Internet Protocol) addresses by additional requests from the client machine. Typically address resolution is made by a name server that has access to a file that relates DNS names with IP addresses. (See, for example, “Domain Name System,” downloaded from Wikipedia.) More generally, DNS names and IP addresses can be described as network names and network addresses.

Client-based address resolution for the resource requests can be time consuming, for example, due to network delays and poor infrastructure on the client's network. During this time, the browser may show no image or partial images. Thus, there is a need for improved resolution of resource requests that relate network names with network addresses.

### SUMMARY OF THE INVENTION

In one embodiment of the present invention, a method of resolving network addresses in a network, includes: receiving a network address for a client; accessing a document for the client, wherein the document includes one or more resource requests that each include a corresponding resource network name; resolving one or more resource network addresses for the one or more resource requests; and providing to the client's network address a resolved configuration corresponding to the document, wherein the resolved configuration includes the one or more resource network addresses.

According to one aspect of this embodiment, a display corresponding to the resolved configuration can be performed at the client. Additionally, one or more values for the resolved configuration can be saved in a computer-readable medium for later display. For example, values can be saved directly or through some related characterization at the server or the client in memory (e.g., RAM (Random Access Memory)) or permanent storage (e.g., a hard-disk system).

According to another aspect, each resource network name may include a DNS (Domain Name System) name, and each resource network address may include an IP (Internet Protocol) address.

According to another aspect, the document may include a web page (e.g., stored as an HTML (HyperText Markup Language) file) and the client may includes a processor with memory, a network connection, and a display for viewing the web page.

According to another aspect, resolving the one or more resource network addresses may include accessing a file that associates network names with network addresses.

According to another aspect, resolving the one or more resource network addresses may include: accessing location information for the client; and using the location information to access at least one resource network address from a file that associates network names with network addresses for different client locations.

According to another aspect, providing the resolved configuration may include replacing values for one or more resource network names in the document with corresponding values for one or more resource network addresses.

Additional embodiments relate to an apparatus for carrying out any one of the above-described methods, where the apparatus includes a computer for executing instructions related to the method. For example, the computer may include a processor with memory for executing at least some of the instructions. Additionally or alternatively the computer may include circuitry or other specialized hardware for executing at least some of the instructions. Additional embodiments also relate to a computer-readable medium that stores (e.g., tangibly embodies) a computer program for carrying out any one of the above-described methods with a computer. In these ways the present invention enables improved resolution of resource requests that relate network names with network addresses.

### BRIEF DESCRIPTION OF THE DRAWINGS

FIG. 1 shows a method of resolving network addresses according to an embodiment of the present invention.

FIG. 2 shows a portion of an exemplary web page display for the embodiment shown in FIG. 1.

FIG. 3 shows an exemplary resource request that includes a DNS name with a corresponding IP address for the embodiment shown in FIG. 1.

FIG. 4 shows a conventional general-purpose computer.

FIG. 5 shows a conventional Internet network configuration.

### DETAILED DESCRIPTION OF EXEMPLARY EMBODIMENTS

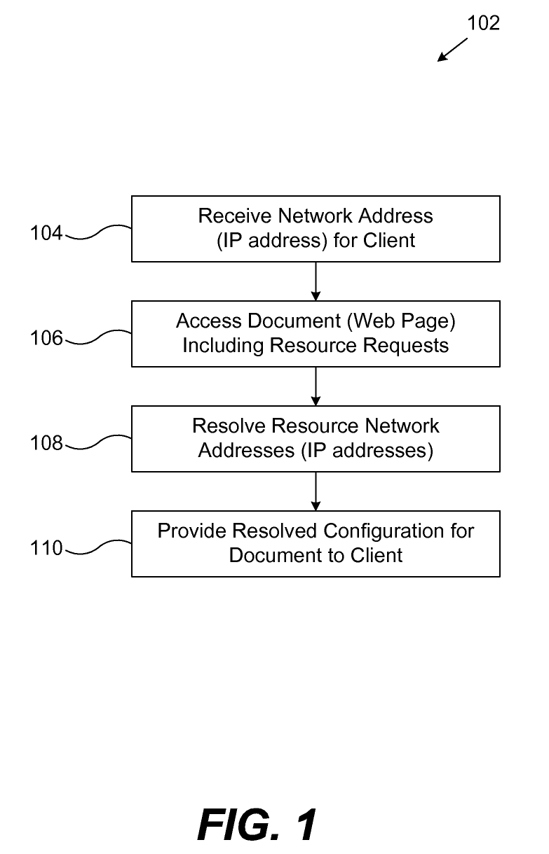

An embodiment of the present invention is shown in FIG. 1. A method 102 of resolving network addresses in a network includes: receiving a network address (e.g., an IP address) for a client 104; accessing a document (e.g., a web page) that includes resource requests 106; resolving resource network addresses (e.g., IP addresses) for the resource requests 108; and providing a resolved configuration for the document to the client (or the client's network address) with the resource network addresses included in the resolved configuration 110.

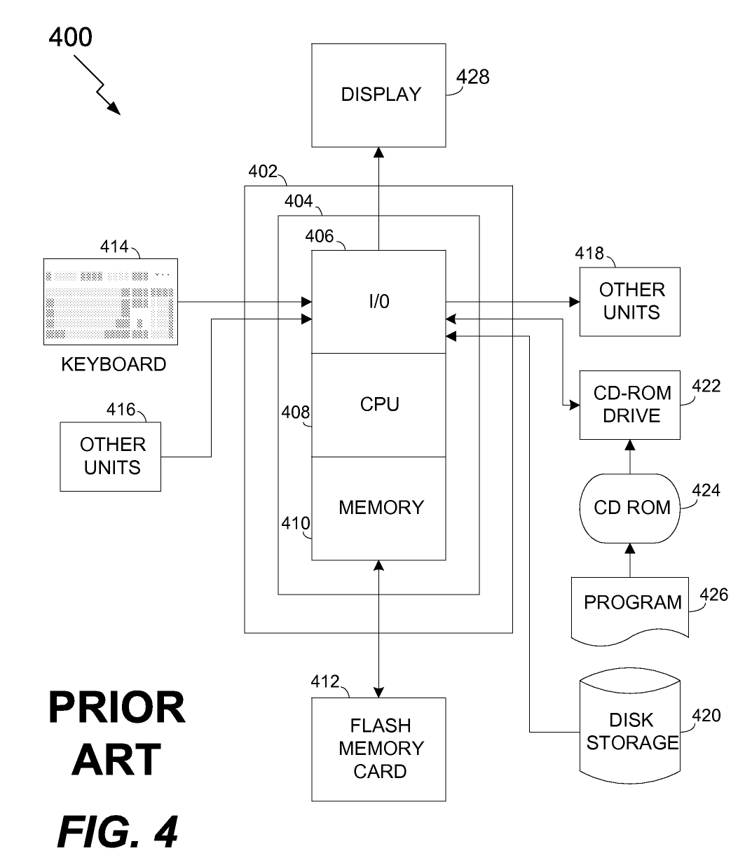

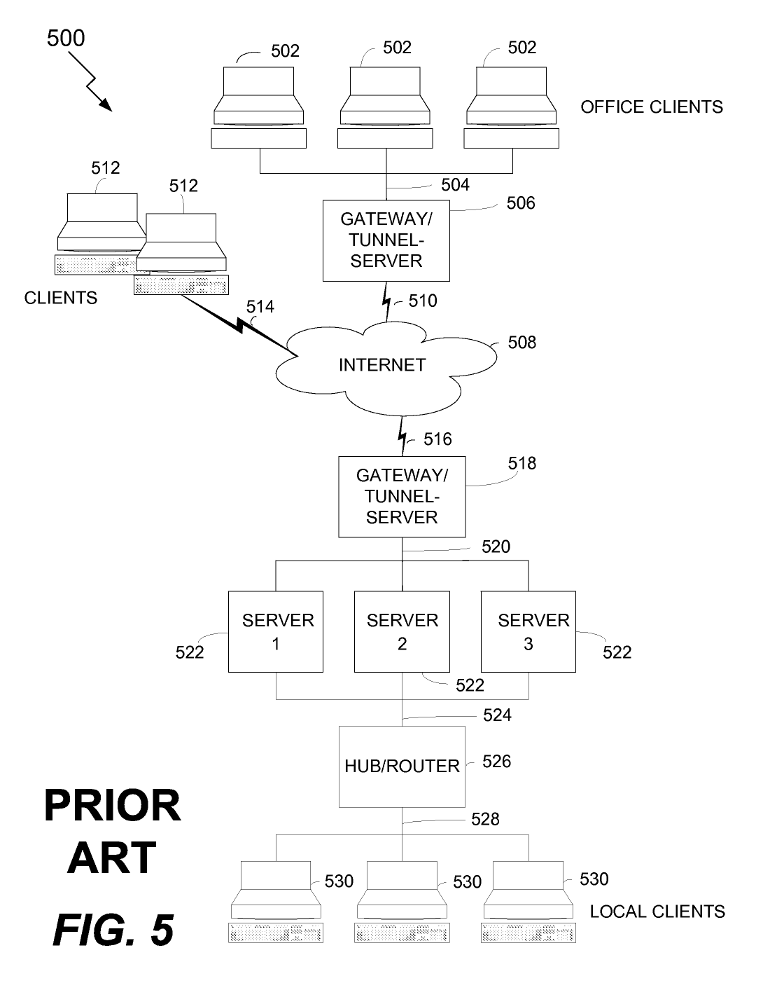

The method 102 can be carried out by a server that connects to a client in a network that may include the Internet, where the server and client may each include a conventional computer(e.g., with processor, memory and display). Conventional computers and networks are discussed below with reference to FIGS. 4 and 5. Communications between a server and client can be carried out through a conventional web browser (e.g., Microsoft Internet Explorer). For example, the server can receive the IP address for the client after the client uses the browser to access a domain name corresponding to the server (e.g., yahoo.com). The resolved configuration for the document can be provided to the client (or at least the client's IP address) as a conventional file transfer through the browser software.

Resource requests typically include network names (e.g, DNS names) that must be translated to equivalent network addresses (IP addresses) to access display information for a web page. For example, a text-based document stored as an HTML (HyperText Markup Language) file) may represent a web page with graphical elements that are specified by network addresses for these graphical elements (e.g., as accessible files). Displaying the web page at the client machine requires accessing these elements over the network.

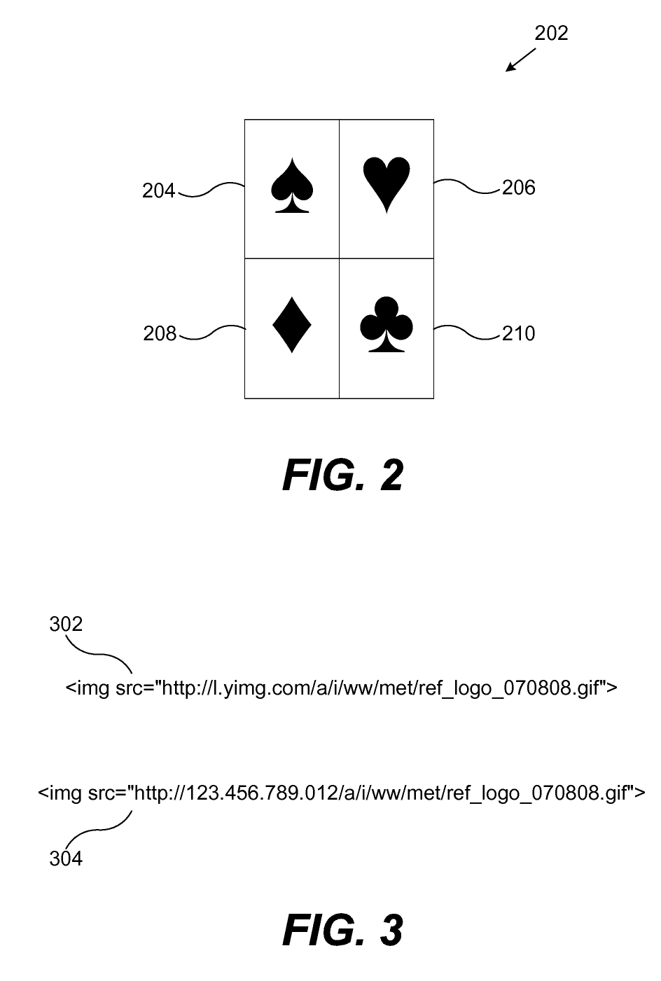

For example, FIG. 2 illustrates a portion 202 of a web page display with four graphical elements, a spade 204, a heart 206, a diamond 208, and a club 210. In a corresponding text-based document each graphical element is characterized by a resource request 302 that includes a DNS name (e.g., “1.yimg.com”) as shown in FIG. 3. In a corresponding resolved resource request 304, the DNS name has been replaced by a corresponding IP address (e.g., “123.456.789.012”). In this case, a resolved configuration for the document includes resolved resource requests for the four graphical images 204, 206, 208, 210. For example, the resolved configuration may be generated from the document (e.g., an HTML file) by replacing each DNS name in a resource request with a corresponding IP address so that each resource request 302 is replaced by a resolved resource request 304. This modified document (e.g., another HTML file) can then be directed to the client's IP address over the network as a conventional file transfer.

Address resolution by the server (possibly through another network sever, e.g., a name server) can be done by accessing a file that associates network names with network addresses. In some operational settings multiple network addresses may be associated with the network and the address resolution can be carried out to optimize resources in some way (e.g., by finding a network address based on proximity to the physical location of the client or other load-balancing based on different client locations).

The resolved configuration can be used at the client to display the web page (e.g., as in FIG. 2). Alternatively the resolved configuration can be saved at the client or at the sever for later display according to the requirements of the operational setting. In some operational settings the resolved configuration may retain one or more DNS names in the resource requests because corresponding IP addresses are uncertain or likely to change. Under these conditions, the resolved configuration still includes one or more DNS names that must be resolved in order to display the web page for the client,

Additional embodiments relate to an apparatus for carrying out any one of the above-described methods, where the apparatus includes a computer for executing computer instructions related to the method. In this context the computer may be a general-purpose computer including, for example, a processor, memory, storage, and input/output devices (e.g., keyboard, display, disk drive, Internet connection, etc.). However, the computer may include circuitry or other specialized hardware for carrying out some or all aspects of the method. In some operational settings, the apparatus may be configured as a system that includes one or more units, each of which is configured to carry out some aspects of the method either in software, in hardware or in some combination thereof. For example, the system may be configured as part of a computer network that includes the Internet. At least some values for the results of the method can be saved for later use in a computer-readable medium, including memory (e.g., RAM (Random Access Memory)) and permanent storage (e.g., a hard-disk system).

Additional embodiments also relate to a computer-readable medium that stores (e.g., tangibly embodies) a computer program for carrying out any one of the above-described methods by means of a computer. The computer program may be written, for example, in a general-purpose programming language (e.g., C, C++) or some specialized application-specific language. The computer program may be stored as an encoded file in some useful format (e.g., binary, ASCII).

As described above, certain embodiments of the present invention can be implemented using standard computers and networks including the Internet. FIG. 4 shows a conventional general purpose computer 400 with a number of standard components. The main system 402 includes a motherboard 404 having an input/output (I/O) section 406, one or more central processing units (CPU) 408, and a memory section 410, which may have a flash memory card 412 related to it. The I/O section 406 is connected to a display 428, a keyboard 414, other similar general-purpose computer units 416, 418, a disk storage unit 420 and a CD-ROM drive unit 422. The CD-ROM drive unit 422 can read a CD-ROM medium 424 which typically contains programs 426 and other data.

FIG. 5 shows a conventional Internet network configuration 500, where a number of office client machines 502, possibly in a branch office of an enterprise, are shown connected 504 to a gateway/tunnel-server 506 which is itself connected to the Internet 508 via some internet service provider (ISP) connection 510. Also shown are other possible clients 512 similarly connected to the Internet 508 via an ISP connection 514. An additional client configuration is shown for local clients 530 (e.g., in a home office). An ISP connection 516 connects the Internet 508 to a gateway/tunnel-server 518 that is connected 520 to various enterprise application servers 522. These servers 522 are connected 524 to a hub/router 526 that is connected 528 to various local clients 530.

Although only certain exemplary embodiments of this invention have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

What is claimed is:

1. A method of resolving network addresses in a network, comprising:
receiving a network address for a client;
accessing a document for the client, wherein the document includes one or more resource requests that each include a corresponding resource network name;
resolving one or more resource network addresses for the one or more resource requests;
providing to the client's network address a resolved configuration corresponding to the document, wherein the resolved configuration includes the one or more resource network addresses; and
saving one or more values for the resolved configuration in a computer-readable medium.

2. A method according to claim 1, wherein each resource network name includes a DNS (Domain Name System) name, and each resource network address includes an IP (Internet Protocol) address.

3. A method according to claim 1, wherein the document includes a web page, and the client includes a processor with memory, a network connection, and a display for viewing the web page.

4. A method according to claim 1, wherein resolving the one or more resource network addresses includes:
accessing a file that associates network names with network addresses.

5. A method according to claim 1, wherein resolving the one or more resource network addresses includes:
accessing location information for the client from the client's network address; and
using the location information to access at least one resource network address from a file that associates network names with network addresses for different client locations.

6. A method according to claim 1, wherein providing the resolved configuration includes:
replacing values for one or more resource network names in the document with corresponding values for one or more resource network addresses.

7. A computer-readable medium that stores a computer program for resolving network addresses in a network, wherein the computer program includes instructions for:
receiving a network address for a client;
accessing a document for the client, wherein the document includes one or more resource requests that each include a corresponding resource network name;
resolving one or more resource network addresses for the one or more resource requests; and
providing to the client's network address a resolved configuration corresponding to the document, wherein the resolved configuration includes the one or more resource network addresses.

8. A computer-readable medium according to claim 7, wherein each resource network name includes a DNS (Domain Name System) name, and each resource network address includes an IP (Internet Protocol) address.

9. A computer-readable medium according to claim 7, wherein the document includes a web page, and the client includes a processor with memory, a network connection, and a display for viewing the web page.

10. A computer-readable medium according to claim 7, wherein resolving the one or more resource network addresses includes:
accessing a file that associates network names with network addresses.

11. A computer-readable medium according to claim 7, wherein resolving the one or more resource network addresses includes:
accessing location information for the client from the client's network address; and
using the location information to access at least one resource network address from a file that associates network names with network addresses for different client locations.

12. A computer-readable medium according to claim 7, wherein providing the resolved configuration includes:
replacing values for one or more resource network names in the document with corresponding values for one or more resource network addresses.

13. An apparatus for resolving network addresses in a network, the apparatus comprising a computer for executing computer instructions, wherein the computer includes computer instructions for:
receiving a network address for a client;
accessing a document for the client, wherein the document includes one or more resource requests that each include a corresponding resource network name;
resolving one or more resource network addresses for the one or more resource requests; and
providing to the client's network address a resolved configuration corresponding to the document, wherein the resolved configuration includes the one or more resource network addresses.

14. An apparatus according to claim 13, wherein each resource network name includes a DNS (Domain Name System) name, and each resource network address includes an IP (Internet Protocol) address.

15. An apparatus according to claim 13, wherein the document includes a web page, and the client includes a processor with memory, a network connection, and a display for viewing the web page.

16. An apparatus according to claim 13, wherein resolving the one or more resource network addresses includes:
accessing a file that associates network names with network addresses.

17. An apparatus according to claim 13, wherein resolving the one or more resource network addresses includes:
accessing location information for the client from the client's network address; and
using the location information to access at least one resource network address from a file that associates network names with network addresses for different client locations.

18. An apparatus according to claim 13, wherein providing the resolved configuration includes:
replacing values for one or more resource network names in the document with corresponding values for one or more resource network addresses.

19. An apparatus according to claim 13, wherein the computer includes a processor with memory for executing at least some of the computer instructions.

20. An apparatus according to claim 13, wherein the computer includes circuitry for executing at least some of the computer instructions.
